(19) United States
(12) Patent Application Publication
(10) Pub. No.: US 2026/0153770 A1
(43) Pub. Date: Jun. 4, 2026

(54) DISPLAY PANEL AND DISPLAY APPARATUS

(71) Applicant: Xiamen Tianma Optoelectronics Co., Ltd., Xiamen (CN)

(72) Inventors: Zhe Piao, Xiamen (CN); Jiaqi Kang, Xiamen (CN); Dongquan Hou, Xiamen (CN); Wanyu Su, Xiamen (CN); Xurui Ma, Xiamen (CN); Kaiming Sun, Xiamen (CN)

(73) Assignee: Xiamen Tianma Optoelectronics Co., Ltd., Xiamen (CN)

(21) Appl. No.: 19/457,463

(22) Filed: Jan. 23, 2026

(30) Foreign Application Priority Data
Sep. 29, 2025 (CN) 202511415004.0

(51) Int. Cl. G02F 1/1339; G02F 1/1343

(52) U.S. Cl. CPC G02F 1/13394; G02F 1/134336

(57) ABSTRACT

Provided are a display panel and a display apparatus. The display panel includes first and second substrates provided opposite to each other, and photo spacers located therebetween. The second substrate includes an underlay, an insulating layer, and an electrode layer. The insulating layer includes a first region and a second region. The first region is thinner than the second region. The electrode layer includes pixel electrodes, and a projection of at least a partial region of each pixel electrode onto the underlay is located within a projection of the first region onto the underlay, and a projection of the photo spacer onto the underlay is located within a partial region of the second region.

### CROSS-REFERENCE TO RELATED APPLICATION

The present application claims priority to Chinese Patent Application No. 202511415004.0, filed on Sep. 29, 2025, the content of which is incorporated herein by reference in its entirety.

### TECHNICAL FIELD

The present application relates to the field of display technologies, and in particular, to a display panel and a display apparatus.

### BACKGROUND

Liquid Crystal Display (LCD) panels are currently the most widely used display products on the market, featuring mature production process technology, high product yield, relatively low production cost, and high market acceptance. Generally, an LCD panel consists of a color filter substrate, an array substrate, liquid crystal sandwiched between the color filter substrate and the array substrate, photo spacers and a sealing frame adhesive. In the prior art, when a display panel is subjected to an external impact, the photo spacers tend to slide and cause damage to a PI alignment film on the array substrate side, generating debris that floats inside the display panel and thus leading to display defects. Therefore, the structure of the liquid crystal display panel needs to be further improved.

### SUMMARY

The present application provides a display panel and a display apparatus. By performing thinning treatment on a partial region of an insulating layer, the probability that photo spacers scratch a PI alignment film and the probability of debris generation is reduced, thereby ensuring the display effect of the display panel.

In a first aspect, the present application provides a display panel, including a first substrate and a second substrate provided opposite to each other, and a plurality of photo spacers located between the first substrate and the second substrate;
where a first end of a respective photo spacer is fixed on a side of the first substrate close to the second substrate, and a second end of the photo spacer either contacts the second substrate or is spaced apart from the second substrate by a preset interval; and
where the second substrate includes an underlay, and an insulating layer and an electrode layer stacked on one side of the underlay, the insulating layer includes a first region and a second region, and a thickness of the first region is smaller than a thickness of the second region; the electrode layer includes a plurality of pixel electrodes, and a projection of at least a partial region of a respective pixel electrode onto the underlay is located within a projection of the first region onto the underlay, a partial region of the second region is a photo spacer corresponding region, and a projection of the second end of the photo spacer onto the underlay is located within the photo spacer corresponding region.

In a second aspect, the present application provides a display apparatus including the display panel according to any one of the first aspect.

In the technical solutions of the embodiments of the present application, a display panel is provided, which includes a first substrate and a second substrate provided opposite to each other, and a plurality of photo spacers located between the first substrate and the second substrate, where a first end of a respective photo spacer is fixed on a side of the first substrate close to the second substrate, and a second end of the photo spacer either contacts the second substrate or is spaced apart from the second substrate by a preset interval; the second substrate includes an underlay, and an insulating layer and an electrode layer stacked on one side of the underlay, the insulating layer includes a first region and a second region, and the second region is subjected to a thinning treatment, such that a thickness of the first region is less than a thickness of the second region, thereby effectively improving the light transmittance; and the electrode layer includes a plurality of pixel electrodes, a projection of at least a partial region of a respective pixel electrode onto the underlay is located within a projection of the first region onto the underlay, a partial region of the second region is a photo spacer corresponding region, and a projection of the second end of the photo spacer onto the underlay is located within the photo spacer corresponding region. Whereby, a part of the pixel electrode is located in the first region or the entire pixel electrode is located in the first region, and the photo spacer is located in the second region, so that when the display panel is subjected to an external impact, the sliding distance of the photo spacer is reduced, avoiding debris generation caused by the photo spacer scratching the PI alignment film, reducing the probability of film layer debris generation, and ensuring the display effect of the display panel.

It should be understood that the content described in this section is not intended to identify the key or important features of the embodiments of the present application, nor is it used to limit the scope of the present application. Other features of the present application will become easily understandable through the following description.

### BRIEF DESCRIPTION OF DRAWINGS

To more clearly illustrate the technical solutions in the embodiments of the present application, the accompanying drawings required for describing the embodiments will be briefly introduced below. Apparently, the accompanying drawings in the following description are merely some embodiments of the present application, and for those of ordinary skill in the art, other accompanying drawings can also be obtained based on these accompanying drawings without creative efforts.

FIG. 1 is a schematic structural view of a display panel according to an embodiment of the present application.

FIG. 2 is a schematic cross-sectional view of FIG. 1 taken along section line A1-A2.

FIG. 3 is a schematic cross-sectional view of FIG. 1 taken along section line B1-B2.

FIG. 4 is a schematic cross-sectional view of FIG. 1 taken along section line C1-C2.

FIG. 5 is a schematic structural view of another display panel according to an embodiment of the present application.

FIG. 6 is a schematic structural view of another display panel according to an embodiment of the present application.

FIG. 7 is a schematic structural view of another display panel according to an embodiment of the present application.

FIG. 8 is a schematic structural view of another display panel according to an embodiment of the present application.

FIG. 9 is a schematic structural view of another display panel according to an embodiment of the present application.

FIG. 10 is a schematic cross-sectional view of FIG. 9 taken along section line D1-D2.

FIG. 11 is a schematic cross-sectional view of FIG. 9 taken along section line E1-E2.

FIG. 12 is a schematic cross-sectional view of FIG. 9 taken along section line F1-F2.

FIG. 13 is a schematic structural view of another display panel according to an embodiment of the present application.

FIG. 14 is a schematic structural view of a display panel according to an embodiment of the present application.

FIG. 15 is a schematic structural view of another display panel according to an embodiment of the present application.

FIG. 16 is a schematic cross-sectional view of FIG. 15 taken along section line G1-G2.

FIG. 17 is a schematic cross-sectional view of FIG. 15 taken along section line H1-H2.

FIG. 18 is a schematic structural view of another display panel according to an embodiment of the present application.

FIG. 19 is a schematic cross-sectional view of FIG. 18 taken along section line I1-I2.

FIG. 20 is a schematic cross-sectional view of FIG. 18 taken along section line J1-J2.

FIG. 21 is a schematic cross-sectional view of FIG. 18 taken along section line K1-K2.

FIG. 22 is a schematic structural view of another display panel according to an embodiment of the present application.

FIG. 23 is a schematic cross-sectional view of FIG. 22 taken along section line L1-L2.

FIG. 24 is a schematic cross-sectional view of FIG. 22 taken along section line M1-M2.

FIG. 25 is a schematic cross-sectional view of FIG. 22 taken along section line N1-N2.

FIG. 26 is a schematic structural view of another display panel according to an embodiment of the present application.

FIG. 27 is a schematic cross-sectional view of FIG. 26 taken along section line O1-O2.

FIG. 28 is a schematic structural view of another display panel according to an embodiment of the present application.

FIG. 29 is a schematic cross-sectional view of FIG. 28 taken along section line P1-P2.

FIG. 30 is a schematic structural view of another display panel according to an embodiment of the present application.

FIG. 31 is a schematic cross-sectional view of FIG. 30 taken along section line Q1-Q2.

FIG. 32 is a schematic cross-sectional view of FIG. 30 taken along section line R1-R2.

FIG. 33 is a schematic structural view of another display panel according to an embodiment of the present application.

FIG. 34 is a schematic cross-sectional view of FIG. 33 taken along section line S1-S2.

FIG. 35 is a schematic structural view of another display panel according to an embodiment of the present application.

FIG. 36 is a schematic structural view of a display apparatus according to an embodiment of the present application.

### DESCRIPTION OF EMBODIMENTS

To enable those of skill in the art to better understand the solutions of the present application, the technical solutions in the embodiments of the present application will be clearly and completely described below in conjunction with the accompanying drawings in the embodiments of the present application. It should be understood that the described embodiments are merely a part of the embodiments of the present application, rather than all of the embodiments. Furthermore, all other embodiments obtained by those of ordinary skill in the art without creative efforts shall be understood to fall within the protection scope of the present application.

It should be noted that the terms such as “first” and “second” in the specification, claims, and the accompanying drawings of the present application are used to distinguish similar objects, rather than necessarily being used to describe a specific order or sequence. It should be understood that the terms used in this way can be interchanged under appropriate circumstances, so that the embodiments of the present application described herein can be implemented in an order other than those illustrated or described herein. Furthermore, the terms “comprise”, “have”, and any variations thereof are intended to cover a non-exclusive inclusion. For example, a process, method, system, product, or apparatus that includes a series of steps or units is not necessarily limited to those steps or units explicitly listed, but may instead include other steps or units that are not explicitly listed or are inherent to the process, method, system, product, or apparatus.

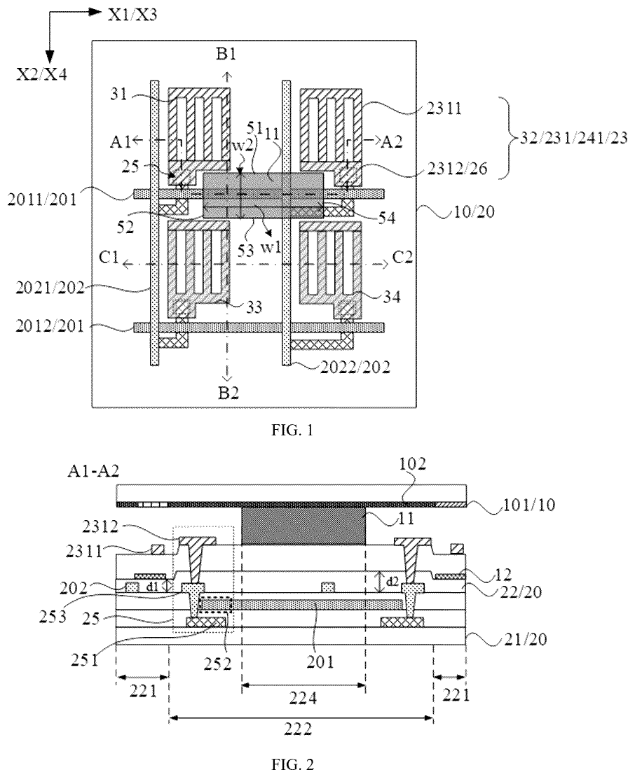

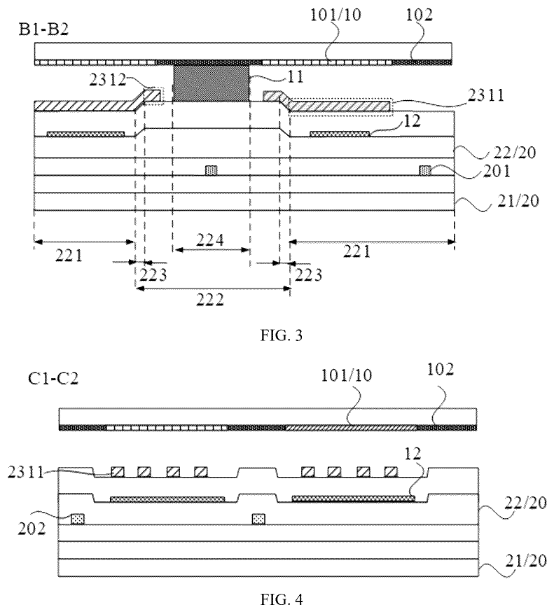

FIG. 1 is a schematic structural view of a display panel according to an embodiment of the present application. FIG. 2 is a schematic cross-sectional view of FIG. 1 taken along section line A1-A2. FIG. 3 is a schematic cross-sectional view of FIG. 1 taken along section line B1-B2. FIG. 4 is a schematic cross-sectional view of FIG. 1 taken along section line C1-C2. According to the exemplary embodiments shown in FIG. 1, FIG. 2, FIG. 3, and FIG. 4, the display panel includes a first substrate 10 and a second substrate 20 provided opposite to each other, and a plurality of photo spacers 11 located between the first substrate 10 and the second substrate 20, a first end of a respective photo spacer 11 is fixed on a side of the first substrate 10 close to the second substrate 20, and a second end of the photo spacer 11 either contacts the second substrate 20 or is spaced apart from the second substrate 20 by a preset interval. The second substrate 20 includes an underlay 21, as well as an insulating layer 22 and an electrode layer 23 stacked on one side of the underlay 21. The insulating layer 22 includes a first region 221 and a second region 222. In some embodiments, a thickness d1 of the first region 221 is smaller than a thickness d2 of the second region 222. The electrode layer 23 includes a plurality of pixel electrodes 231, and a projection of at least a partial region of a respective pixel electrode 231 onto the underlay 21 is located within a projection of the first region 221 onto the underlay 21. A partial region of the second region 222 is a photo spacer corresponding region 224, and a projection of the second end of the photo spacer 11 onto the underlay 21 is located within the photo spacer corresponding region 224.

The first substrate 10 may be a color filter substrate, and may be provided with color filter structures 101 arranged at intervals. The color filter structures 101 may include a plurality of color resist blocks of different colors; for example, red color resist blocks, green color resist blocks, and blue color resist blocks. The plurality of color resist blocks may be used for realizing the color display of the display panel. Further, a light-shielding unit 102 may be provided between adjacent color filter structures 101. The light-shielding unit 102 can avoid light crosstalk and ensure the display effect of the display panel.

The second substrate 20 may be an array substrate and may further include a plurality of scan lines 201, a plurality of data lines 202, and pixel circuits. In some embodiments, the pixel circuits are configured to provide display signals to the pixel electrodes 231, thereby ensuring the normal display of the display panel. A respective pixel circuit may include a thin film transistor 25. The thin film transistor 25 includes an active layer 251, a gate 252, a source (not shown in FIG. 2), and a drain 253. A respective scan line 201 is electrically connected to the gate 252 (the scan line 201 and the gate 252 are in a same layer, and a partial region of the scan line 201 forms the gate 252 of a corresponding thin film transistor 25).

According to the exemplary embodiment shown in FIG. 2 shows that the pixel electrode 231 is electrically connected to the drain 253, and a respective data line 202 is electrically connected to the source. In other embodiments, the pixel electrode 231 is also designed to be electrically connected to the source, and the data line 202 is also designed to be electrically connected to the drain. During specific implementation, the design may be made according to actual conditions. In this embodiment, the source and the drain 253 are provided in the same layer as the data line 202. The pixel electrode 231 of the electrode layer 23 in the second substrate 20 may first be electrically connected to the drain 253 which is in the same layer as the data line 202 by forming a hole in the insulating layer 22 extending to the film layer where the data line 202 is located, and then electrically connected to the active layer 251 through the drain 253. When the thin film transistor 25 is turned on, the normal transmission of a display control signal is realized.

In some embodiments, a liquid crystal layer (not shown in FIG. 2 and FIG. 3) is further provided between the first substrate 10 and the second substrate 20. The liquid crystal layer includes a plurality of liquid crystal molecules therein, which can deflect under the action of an electric field. Light emitted by a backlight module (not shown in FIG. 2 and FIG. 3) exits from the first substrate 10 under the action of the liquid crystal molecules, enabling the display panel to realize the display function.

In some embodiments, the plurality of photo spacers 11 are further provided between the first substrate 10 and the second substrate 20. A projection shape of the photo spacer 11 onto the underlay 21 may be rectangular, circular, oval, or other shapes, and a cross-sectional shape of the photo spacer 11 may be rectangular, trapezoidal, semicircular, or other shapes. The shape of the photo spacer 11 may be selected according to actual design requirements, which is not specifically limited in the embodiments of the present application. In the embodiments of the present application, the projection shape and cross-sectional shape of the photo spacer are taken as rectangular for illustration. The first ends of the photo spacers 11 are fixed on the side of the first substrate 10 close to the second substrate 20, the second ends of a part of the photo spacers 11 contact the second substrate 20, and this part of the photo spacers 11 can provide thickness support for a liquid crystal cell where the liquid crystal layer is located, ensuring the thickness uniformity of the liquid crystal cell and the display uniformity. The second ends of another part of the photo spacers 11 are spaced apart from the second substrate 20 by the preset interval, i.e., not in contact with the second substrate 20, this part of the photo spacers 11 can share an external force when the display panel is subjected to an external impact, playing a certain buffering role, and can restore the display panel to its original state after the external force disappears, thereby ensuring the display effect of the display panel.

In some embodiments, the second substrate 20 includes the underlay 21, and the insulating layer 22 and the electrode layer 23 stacked on one side of the underlay 21. The insulating layer 22 is provided as an entire layer and may be a planarization layer. A via hole is further provided in the insulating layer 22 to allow the pixel electrode 231 to be electrically connected to the drain 253 of the thin film transistor 25 through the via hole. That is, the insulating layer 22 is provided on a side of the thin film transistor 25 close to the first substrate 10, so as to resolve a step difference caused by the thin film transistor 25. A partial region of the insulating layer 22 is subjected to thinning treatment. In some embodiments, the insulating layer 22 includes the first region 221 and the second region 222, where the thickness d1 of the first region 221 is smaller than the thickness d2 of the second region 222. The first region 221 sinks relative to the second region 222, and its smaller thickness can improve the light transmittance on a backlight substrate side. A partial region of the second region 222 is the photo spacer corresponding region 224. The projection of the second end of the photo spacer 11 onto the underlay 21 is located within the photo spacer corresponding region 224, and the projection of at least a partial region of the pixel electrode 231 in the electrode layer 23 onto the underlay 21 is located within the projection of the first region 221 onto the underlay 21.

According to the exemplary embodiments shown in FIG. 1 to FIG. 4, a part of the pixel electrodes 231 may be provided in the first region 221, and the other part of the pixel electrodes 231 may be provided in the second region 222. In this case, the pixel electrodes 231 located in the second region 222 can play a limiting effect on the photo spacers 11, reducing the sliding range of the photo spacers 11, which avoids debris generation caused by the photo spacers 11 scratching a PI alignment film on the surface of the pixel electrodes 231 due to the sliding of the photo spacers 11, reduces the probability of dynamic pressure-induced bright spots occurring, and ensures the display effect of the display panel. Alternatively, all of the pixel electrodes 231 may be located in the first region 221, thereby avoiding debris generation caused by the photo spacers 11 scratching the PI alignment film, reducing the probability of dynamic pressure-induced bright spots occurring, and ensuring the display effect of the display panel.

On the basis of the above embodiments, there may be different arrangement modes for the relative positions of the data line 202, the scan line 201, the pixel electrode 231, and the photo spacer 11. Several feasible arrangement modes are exemplified below. In some embodiments, the data line 202 includes a first data line 2021 and a second data line 2022; the scan line 201 includes a first scan line 2011 and a second scan line 2012; and the pixel electrode 231 includes a first pixel electrode 31, a second pixel electrode 32, a third pixel electrode 33, and a fourth pixel electrode 34. The first pixel electrode 31 and the second pixel electrode 32 are arranged along a first direction X1; the third pixel electrode 33 and the fourth pixel electrode 34 are arranged along the first direction X1; the first pixel electrode 31 and the third pixel electrode 33 are arranged along a second direction X2; and the second pixel electrode 32 and the fourth pixel electrode 34 are arranged along the second direction X2.

In some embodiments, such as the exemplary embodiment shown in FIG. 1, along the first direction X1, the first data line 2021, the first pixel electrode 31, the second data line 2022, and the second pixel electrode 32 are arranged in sequence, the first data line 2021; the third pixel electrode 33, the second data line 2022, and the fourth pixel electrode 34 are arranged in sequence. Along the second direction X2, the first pixel electrode 31, the first scan line 2011, the third pixel electrode 33, and the second scan line 2012 are arranged in sequence; and the second pixel electrode 32, the first scan line 2011, the fourth pixel electrode 34, and the second scan line 2012 are arranged in sequence. The first data line 2021 is electrically connected to the first pixel electrode 31 and the third pixel electrode 33 respectively; the second data line 2022 is electrically connected to the second pixel electrode 32 and the fourth pixel electrode 34 respectively; the first scan line 2011 is electrically connected to the first pixel electrode 31 and the second pixel electrode 32 respectively; and the second scan line 2012 is electrically connected to the third pixel electrode 33 and the fourth pixel electrode 34, respectively. A projection of the photo spacer 11 onto the underlay 21 does not overlap projections of the pixel electrodes 231 on the underlay 21, but overlaps a projection of the first scan line 2011 and a projection of the second data line 2022 onto the underlay 21. In the above-mentioned arrangement mode, an extension length of the photo spacer 11 along the first direction X1 may be increased to ensure the support force of the photo spacer 11.

FIG. 5 is a schematic structural view of another display panel according to an embodiment of the present application. According to the exemplary embodiment shown in FIG. 5, along the first direction X1, the first data line 2021, the first pixel electrode 31, the second pixel electrode 32, and the second data line 2022 are arranged in sequence; the first data line 2021, the third pixel electrode 33, the fourth pixel electrode 34, and the second data line 2022 are arranged in sequence. Along the second direction X2, the first pixel electrode 31, the first scan line 2011, the third pixel electrode 33, and the second scan line 2012 are arranged in sequence; and the second pixel electrode 32, the first scan line 2011, the fourth pixel electrode 34, and the second scan line 2012 are arranged in sequence. The first data line 2021 is electrically connected to the first pixel electrode 31 and the third pixel electrode 33 respectively; the second data line 2022 is electrically connected to the second pixel electrode 32 and the fourth pixel electrode 34 respectively; the first scan line 2011 is electrically connected to the first pixel electrode 31 and the second pixel electrode 32 respectively; and the second scan line 2012 is electrically connected to the third pixel electrode 33 and the fourth pixel electrode 34 respectively. A projection of the photo spacer 11 onto the underlay 21 does not overlap projections of the pixel electrodes 231 onto the underlay 21, but overlaps a projection of the first scan line 2011 onto the underlay 21. In the above-mentioned arrangement mode, the shapes and sizes of the active layers of the thin film transistors 25 corresponding to different pixel electrodes 231 are consistent, which reduces the fabrication difficulty, and can also ensure the performance consistency of the thin film transistors 25, thereby ensuring the display uniformity of the display panel.

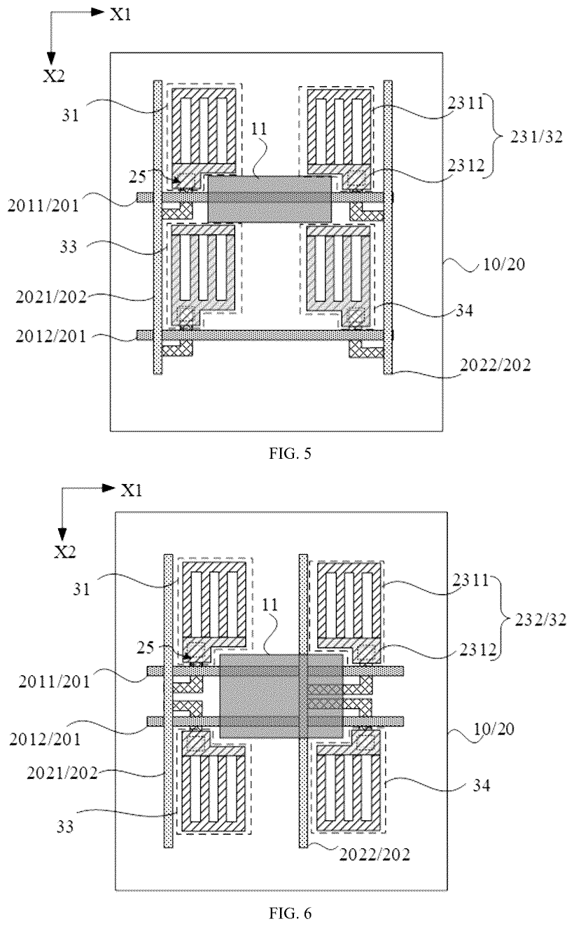

FIG. 6 is a schematic structural view of another display panel according to an embodiment of the present application. According to the embodiment shown in FIG. 6, along the first direction X1, the first data line 2021, the first pixel electrode 31, the second data line 2022, and the second pixel electrode 32 are arranged in sequence; and the first data line 2021, the third pixel electrode 33, the second data line 2022, and the fourth pixel electrode 34 are arranged in sequence. Along the second direction X2, the first pixel electrode 31, the first scan line 2011, the second scan line 2012, and the third pixel electrode 33 are arranged in sequence; and the second pixel electrode 32, the first scan line 2011, the second scan line 2012, and the fourth pixel electrode 34 are arranged in sequence. The first data line 2021 is electrically connected to the first pixel electrode 31 and the third pixel electrode 33 respectively; the second data line 2022 is electrically connected to the second pixel electrode 32 and the fourth pixel electrode 34 respectively; the first scan line 2011 is electrically connected to the first pixel electrode 31 and the second pixel electrode 32 respectively; and the second scan line 2012 is electrically connected to the third pixel electrode 33 and the fourth pixel electrode 34 respectively. A projection of the photo spacer 11 onto the underlay 21 does not overlap projections of the pixel electrodes 231 onto the underlay 21, but overlaps a projection of the first scan line 2011, a projection of the second scan line 2012, and a projection of the second data line 2022 onto the underlay 21. In the above-mentioned arrangement mode, an extension length of the photo spacer 11 along the second direction X2 and an extension length of the photo spacer 11 along the first direction X1 may be increased to ensure the support force of the photo spacer 11.

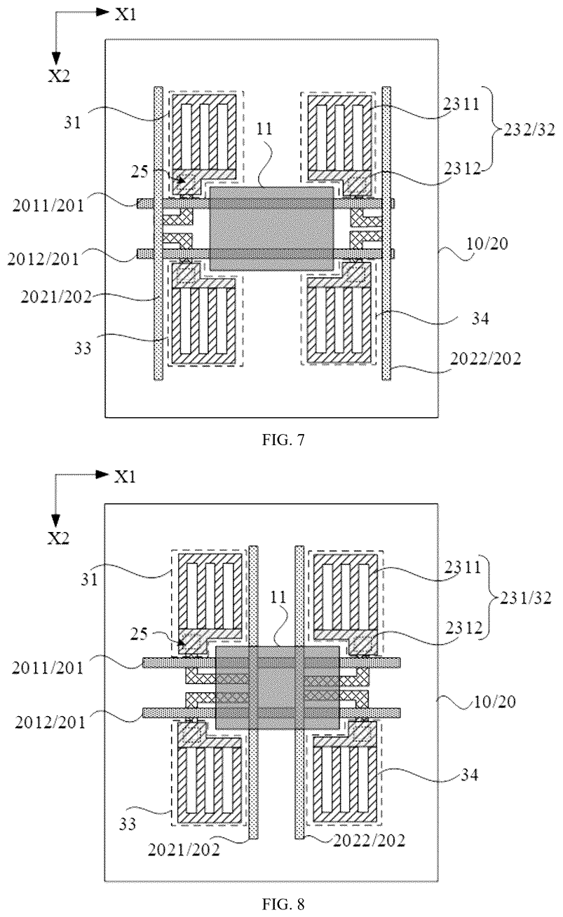

FIG. 7 is a schematic structural view of another display panel according to an embodiment of the present application. According to the embodiment shown in FIG. 7, along the first direction X1, the first data line 2021, the first pixel electrode 31, the second pixel electrode 32, and the second data line 2022 are arranged in sequence; and the first data line 2021, the third pixel electrode 33, the fourth pixel electrode 34, and the second data line 2022 are arranged in sequence. Along the second direction X2, the first pixel electrode 31, the first scan line 2011, the second scan line 2012, and the third pixel electrode 33 are arranged in sequence; and the second pixel electrode 32, the first scan line 2011, the second scan line 2012, and the fourth pixel electrode 34 are arranged in sequence. The first data line 2021 is electrically connected to the first pixel electrode 31 and the third pixel electrode 33 respectively; the second data line 2022 is electrically connected to the second pixel electrode 32 and the fourth pixel electrode 34 respectively; the first scan line 2011 is electrically connected to the first pixel electrode 31 and the second pixel electrode 32 respectively; and the second scan line 2012 is electrically connected to the third pixel electrode 33 and the fourth pixel electrode 34 respectively. A projection of the photo spacer 11 onto the underlay 21 does not overlap projections of the pixel electrodes 231 onto the underlay 21, but overlaps a projection of the first scan line 2011 and a projection of the second scan line 2012 onto the underlay 21. In the above-mentioned arrangement mode, an extension length of the photo spacer 11 along the second direction X2 may be increased to ensure the support force of the photo spacer 11.

FIG. 8 is a schematic structural view of another display panel according to an embodiment of the present application. According to the embodiment shown in FIG. 8, along the first direction X1, the first pixel electrode 31, the first data line 2021, the second data line 2022, and the second pixel electrode 32 are arranged in sequence; and the third pixel electrode 33, the first data line 2021, the second data line 2022, and the fourth pixel electrode 34 are arranged in sequence. Along the second direction X2, the first pixel electrode 31, the first scan line 2011, the second scan line 2012, and the third pixel electrode 33 are arranged in sequence; and the second pixel electrode 32, the first scan line 2011, the second scan line 2012, and the fourth pixel electrode 34 are arranged in sequence. The first data line 2021 is electrically connected to the first pixel electrode 31 and the third pixel electrode 33 respectively; the second data line 2022 is electrically connected to the second pixel electrode 32 and the fourth pixel electrode 34 respectively; the first scan line 2011 is electrically connected to the first pixel electrode 31 and the second pixel electrode 32 respectively; and the second scan line 2012 is electrically connected to the third pixel electrode 33 and the fourth pixel electrode 34 respectively. A projection of the photo spacer 11 onto the underlay 21 does not overlap projections of the pixel electrodes 231 onto the underlay 21, but overlaps a projection of the first scan line 2011 and a projection of the second scan line 2012 onto the underlay 21. In the above-mentioned arrangement mode, an extension length of the photo spacer 11 along the second direction X2 and an extension length of the photo spacer 11 along the first direction X1 may be increased, thereby increasing the projection area of the photo spacer 11 onto the underlay 21 to ensure the support force of the photo spacer 11.

All the above-mentioned modes may ensure that the photo spacer 11 is surrounded by four pixel electrodes 231, reducing the sliding range of the photo spacer 11, avoiding physical damage to the photo spacer 11 (e.g., scratching), and reducing the probability of dynamic pressure-induced bright spots.

In some embodiments, first region and the second regions with different thicknesses are provided in the insulating layer. A part of the pixel electrode is provided in the first region. Alternatively, the entire pixel electrode is provided to be located in the first region, and the photo spacer 11 is provided in the second region. As such, the sliding distance of the photo spacer 11 is reduced when the display panel is subjected to an external impact, avoiding debris generation caused by the photo spacer 11 scratching the PI alignment film, reducing the probability of film layer debris generation, and ensuring the display effect of the display panel.

Further, with continued reference to FIG. 1 to FIG. 4, at least a part of the pixel electrodes 231 include a first electrode 2311 and a second electrode 2312, the first electrode 2311 is electrically connected to the second electrode 2312, the second electrode 2312 is located on a side of the first electrode 2311 close to the photo spacer 11, a projection of the first electrode 2311 onto the underlay 21 is located within the projection of the first region 221 onto the underlay 21, and a projection of the second electrode 2312 onto the underlay 21 is located within a projection of the second region 222 onto the underlay 21.

A part of the pixel electrode 231 may be located in the first region 221 and another part of the pixel electrode 231 may be located in the second region 222. Specifically, the pixel electrode 231 may include the first electrode 2311 and the second electrode 2312, both of which are electrically connected to each other. In some embodiments, the first electrode 2311 is located in the first region 221 and the second electrode 2312 is located in the second region 222. The second electrode 2312 at least partially surrounds the photo spacer 11, such that the second electrode 2312 forms a limiting groove, which can reduce the sliding range of the photo spacer 11, avoiding debris generation caused by the photo spacer 11 scratching the PI alignment film, and reducing the probability of dynamic pressure-induced bright spots occurring.

Further, in some embodiments, an extension direction of the first electrode 2311 and an extension direction of the second electrode 2312 are different. The extension direction of the first electrode 2311 and the extension direction of the second electrode 2312 may be correspondingly selected according to an extension direction of the photo spacer 11. In some embodiments, such as the exemplary embodiments shown in FIG. 1 to FIG. 4, when the photo spacer 11 extends along the first direction X1, the first electrode 2311 may be configured to extend along the second direction X2, and the second electrode 2312 may be configured to extend along the first direction X1 to ensure the limiting effect of the second electrode 2312.

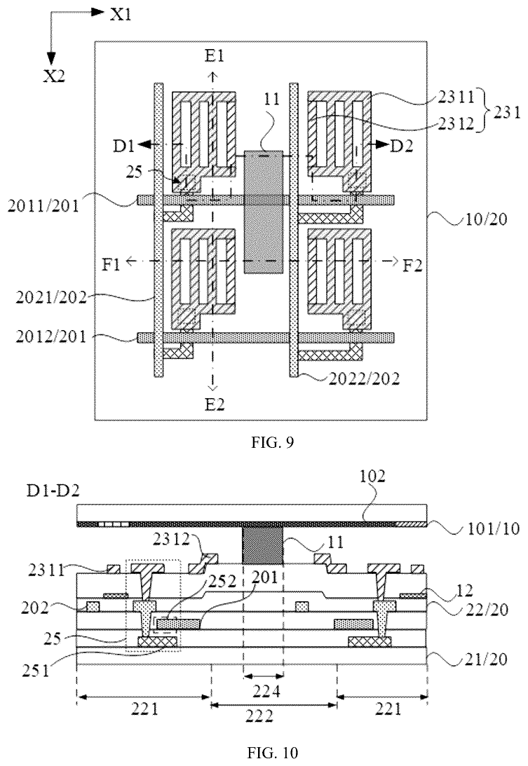

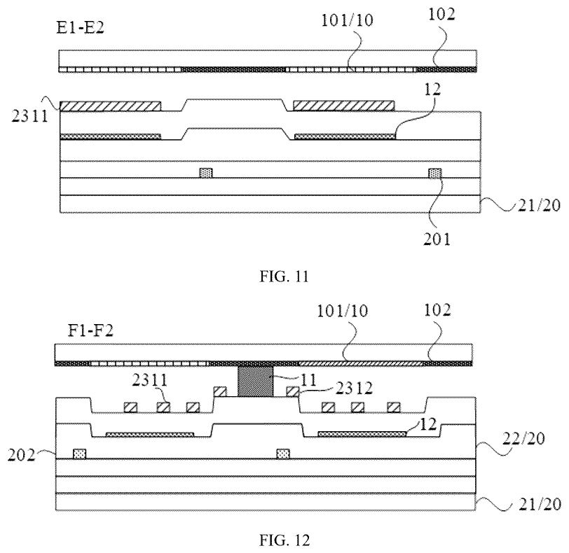

FIG. 9 is a schematic structural view of another display panel according to an embodiment of the present application. FIG. 10 is a schematic cross-sectional view of FIG. 9 taken along section line D1-D2. FIG. 11 is a schematic cross-sectional view of FIG. 9 taken along section line E1-E2. FIG. 12 is a schematic cross-sectional view of FIG. 9 taken along section line F1-F2. According to the embodiments shown in FIG. 9 to FIG. 12, when the photo spacer 11 extends along the second direction X2, the first electrode 2311 may be configured to extend along the first direction X1, and the second electrode 2312 may be configured to extend along the second direction X2. As such, the extension direction of the second electrode 2312 is the same as the extension direction of the photo spacer 11, thereby enabling the second electrode 2312 to effectively limit the sliding range of the photo spacer 11. This prevents the photo spacer 11 from sliding into the first region 221, thereby avoiding debris generation caused by the photo spacers 11 scratching the PI alignment film, reducing the probability of dynamic pressure-induced bright spots occurring, and ensuring the display effect of the display panel.

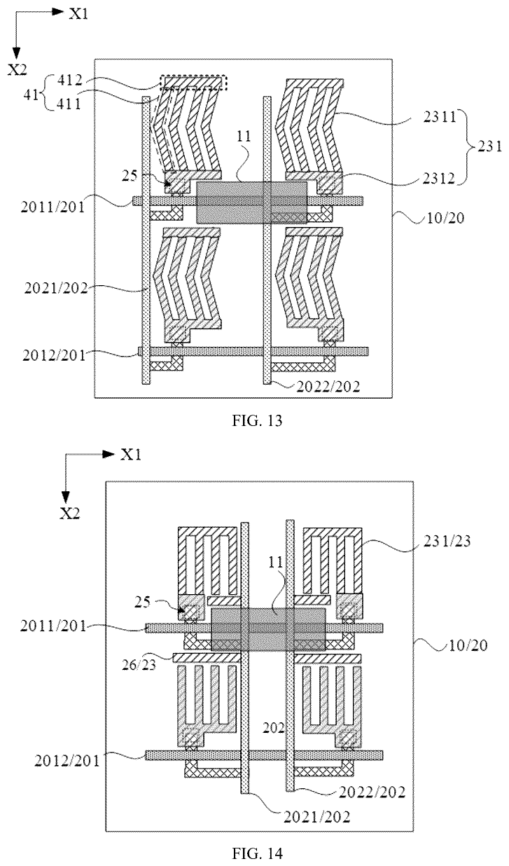

FIG. 13 is a schematic structural view of another display panel according to an embodiment of the present application. According to the embodiment shown in FIG. 13, the first electrode 2311 may be a strip-shaped electrode 41. In some embodiments, the strip-shaped electrode 41 includes a plurality of strip-shaped branches 411 and a connecting portion 412, the plurality of strip-shaped branches 411 are connected via the connecting portion 412, and the plurality of strip-shaped branches 411 are used to form an electric field with a common electrode to control the rotation direction of liquid crystal molecules. There is a hollow part between adjacent strip-shaped branches 411, which is used to form multi-directional electric fields and enhance the regulating capability of liquid crystal alignment, and can also improve the aperture ratio and resolution. According to the embodiments shown in FIG. 1 and FIG. 5 to FIG. 9, the pixel electrode 231 adopts a single-domain structure and has a large light-transmitting area, which is conducive to ensuring high resolution. Alternatively, as shown in FIG. 13, the pixel electrode 231 may adopt a multi-domain structure, and within a same pixel, liquid crystal molecules rotate in two directions to form complementary orientations, thereby effectively reducing color shift and ensuring the display effect.

Further, with continued reference to the exemplary embodiments shown in FIG. 1 to FIG. 4, in the first region 221, a thickness range of the insulating layer 22 is 2.0 μm to 3.0 μm, and in the second region 222, a thickness range of the insulating layer 22 is 2.5 μm to 3.2 μm.

In some embodiments, thinning treatment is performed on the insulating layer 22 in the first region 221, such that a sunken region is formed in the insulating layer 22 in the first region 221, and a thickness of the insulating layer 22 in the first region 221 is smaller than a thickness of the insulating layer 22 in the second region 222. As such, the size of the photo spacer 11 does not need to be adjusted. By reasonably setting the thickness of the insulating layer 22 in the first region 221 and the thickness of the insulating layer 22 in the second region 222, and in combination with providing the photo spacer 11 in the second region 222, debris generation caused by the photo spacer 11 scratching the PI alignment film due to the photo spacer 11 sliding is avoided, the probability of dynamic pressure-induced bright spots occurring is reduced, and the display effect of the display panel is ensured.

With continued reference to FIG. 3, the insulating layer 22 further includes a step region 223 located between the first region 221 and the second region 222; the pixel electrode 231 includes a connecting portion 412 that electrically connects the first electrode 2311 and the second electrode 2312; and, along a direction from the insulating layer 22 to the underlay 21, the connecting portion 412 covers at least a part of the step region 223.

In some embodiments, the step region 223 is further provided between the first region 221 and the second region 222. Due to the limitation of the fabrication process, the first region 221 gradually transitions to the second region 222, such that an extension direction of the surface of the step region 223 intersects with a plane where the first region 221 is located and a plane where the second region 222 is located. As such, a slope shape is formed. To ensure the signal transmission of the pixel electrode 231, the first electrode 2311 located in the first region 221 and the second electrode 2312 located in the second region 222 are connected via the connecting portion 412. Along the direction from the insulating layer 22 to the underlay 21, the connecting portion 412 covers at least a part of the step region 223, thereby ensuring the display effect of the display panel.

FIG. 14 is a schematic structural view of a display panel according to an embodiment of the present application. According to the exemplary embodiments shown in FIG. 1 and FIG. 14, the electrode layer 23 further includes a third electrode 26. The third electrode 26 is located on a side of the pixel electrode 231 adjacent to the photo spacer 11. A projection of the pixel electrode 231 onto the underlay 21 is located within the projection of the first region 221 onto the underlay 21. A projection of the third electrode 26 onto the underlay 21 is located within the projection of the second region 222 onto the underlay 21, and the third electrode 26 is connected to a preset potential.

In some embodiments, the electrode layer 23 further includes the third electrode 26, and the third electrode 26 is located between the photo spacer 11 and the pixel electrode 231. In such embodiments, the pixel electrode 231 is located entirely located within the first region 221, and the third electrode 26 is located within the second region 222, such that the third electrode 26 forms a barrier to the photo spacers 11 to reduce the sliding range of the photo spacer 11. To avoid the third electrode 26 being in a floating state and avoid generating coupling capacitance between the third electrode 26 and the data line 202, which would otherwise affect the display effect of the display panel, the third electrode 26 may be electrically connected to the pixel electrode 231 (as shown in FIG. 1). In this case, the third electrode 26 may serve as a part of the pixel electrode 231, which not only ensures the display effect, but also may play a role in blocking the photo spacer 11. Alternatively, as shown in FIG. 14, the third electrode 26 may be electrically connected to the data line 202 and transmit a same signal as the data line 202, thereby avoiding the occurrence of coupling phenomenon. It should be noted that FIG. 14 merely shows a partial structure and omits some film layers.

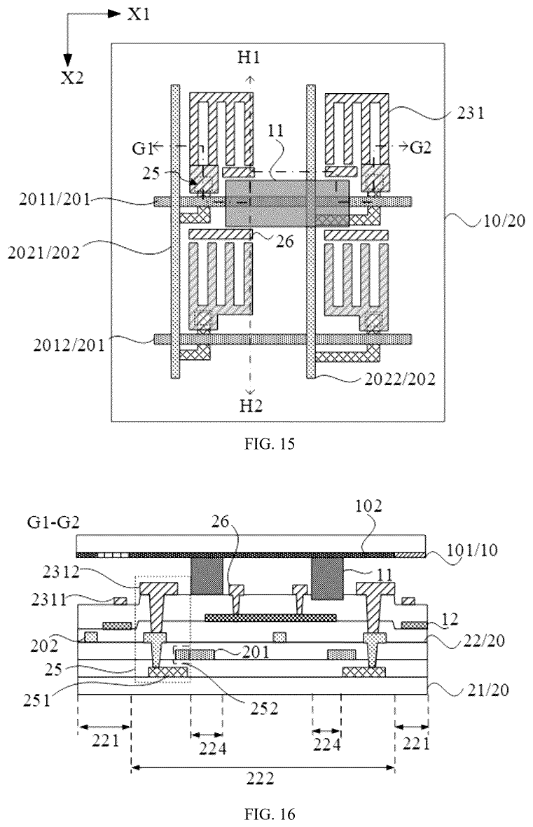

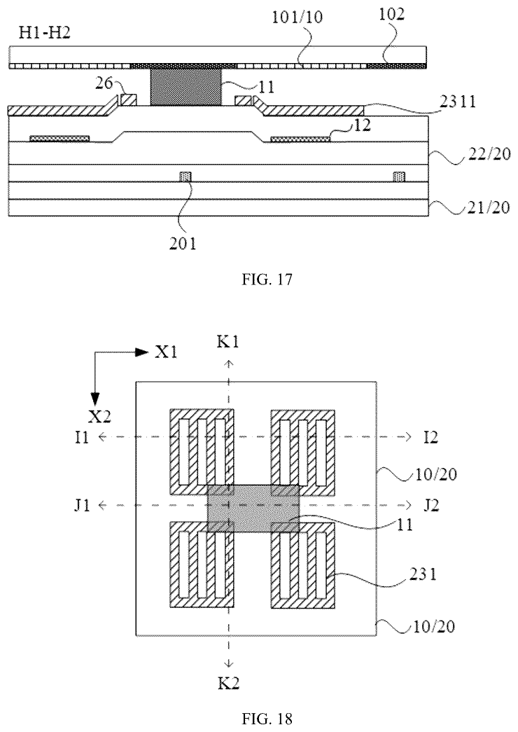

FIG. 15 is a schematic structural view of another display panel according to an embodiment of the present application. FIG. 16 is a schematic cross-sectional view of the exemplary embodiment shown in FIG. 15 taken along section line G1-G2. FIG. 17 is a schematic cross-sectional view of the exemplary embodiment shown in FIG. 15 taken along section line H1-H2. As shown in FIG. 15 to FIG. 17, the second substrate 20 further may include a common electrode 12 located on a side of the pixel electrode 231 close to the underlay 21. In some embodiments, the third electrode 26 is in a same layer as the pixel electrode 231, and the film layer of the common electrode 12 is between the film layer of the pixel electrode 231 and the film layer of the data line 202. The common electrode 12 and the pixel electrode 231 are isolated by an insulating film layer. The third electrode 26 is electrically connected to the common electrode 12 by forming a via hole downward in the insulating film layer, such that the third electrode 26 is connected to a fixed potential, avoiding it being in the floating state and the occurrence of coupling phenomenon. It should be noted that in this embodiment, the common electrode 12 is provided in a lower layer of the pixel electrode 231 and is not shown in the top view of FIG. 1. In other embodiments, the pixel electrode 231 may alternatively be provided between the film layer of the common electrode 12 and the film layer of the data line 202; that is, the common electrode 12 is located in an upper layer of the pixel electrode 231. When the common electrode 12 is in the upper layer, it may adopt a hollowed design similar to that of the pixel electrode 231 in FIG. 1, so as to ensure that the electric field between the pixel electrode 231 and the common electrode 12 controls the liquid crystals in the liquid crystal layer.

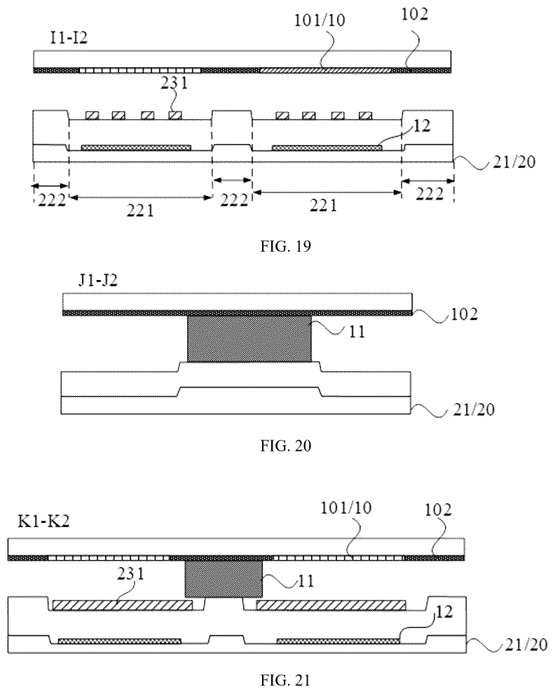

FIG. 18 is a schematic structural view of another display panel according to an embodiment of the present application. FIG. 19 is a schematic cross-sectional view of the exemplary embodiment shown in FIG. 18 taken along section line I1-I2. FIG. 20 is a schematic cross-sectional view of the exemplary embodiment shown in FIG. 18 taken along section line J1-J2. FIG. 21 is a schematic cross-sectional view of the exemplary embodiment shown in FIG. 18 taken along section line K1-K2. As shown in FIG. 18 to FIG. 21, projections of the pixel electrodes 231 onto the underlay 21 are all located within the projection of the first region 221 onto the underlay 21. The pixel electrode 231 may be entirely located within the first region 221. Since the first region 221 is sunken relative to the second region 222 and the photo spacer 11 is located in the second region 222, the second region 222 elevates the photo spacer 11, so that the photo spacer 11 only slides within the second region 222. This avoids the photo spacer 11 from scratching the PI alignment film, reducing the probability of dynamic pressure-induced bright spots occurring. In some embodiments, with continued reference to FIG. 1 to FIG. 4, the electrode layer 23 includes a plurality of pixel electrode groups 241, and a respective pixel electrode group 241 includes four pixel electrodes 231 arranged in a two-by-two (2×2) array; and the four pixel electrodes 231 are provided around the photo spacer 11. The four pixel electrodes 231 arranged in the array are provided around the photo spacer 11, and each pixel electrode 231 is correspondingly provided with a second electrode 2312, such that the photo spacer 11 is limited within an region enclosed by four second electrodes 2312, which limits the sliding range of the photo spacer 11, avoiding the photo spacer 11 scratching the PI alignment film, and avoiding the occurrence of dynamic pressure-induced bright spots.

Further, with continued reference to FIG. 1 to FIG. 4, projections of the four pixel electrodes 231 onto the underlay 21 do not overlap the projection of the second end of the photo spacer 11 onto the underlay 21. In such embodiments, the four pixel electrodes 231 are all configured to be spaced apart from the second end of the photo spacer 11. The four pixel electrodes 231 are used to form the limiting region by surrounding the photo spacer 11, so that the photo spacer 11 can only slide in the limiting region when sliding, which avoids debris generation caused by the photo spacer 11 scratching the PI alignment film, and reduces the probability of dynamic pressure-induced bright spots occurring.

With continued reference to FIG. 1 to FIG. 4, the second substrate 20 further includes a plurality of scan lines 201 extending along a first direction X1 and arranged along a second direction X2, and a plurality of data lines 202 extending along the second direction X2 and arranged along the first direction X1. In some embodiments, four thin film transistors 25 are provided corresponding to the pixel electrode group 241, and the thin film transistors 25 are provided in one-to-one correspondence with the pixel electrodes 231. A control terminal of a respective thin film transistor 25 is connected to a corresponding scan line 201, a first terminal of the thin film transistor 25 is connected to a corresponding data line 202, and a second terminal of the thin film transistor 25 is connected to a corresponding pixel electrode 231. A projection of the thin film transistor 25 onto the underlay 21 does not overlap the projection of the second end of the photo spacer 11 onto the underlay 21.

In some embodiments, the plurality of data lines 202 and the plurality of scan lines 201 are crosswise arranged to define a plurality of pixels arranged in an array. A respective pixel includes a pixel electrode 231 and a thin film transistor 25, and the thin film transistors 25 are provided in one-to-one correspondence with the pixel electrodes 231. The control terminal of the thin film transistor 25 is connected to a scan line 201, the first terminal of the thin film transistor 25 is connected to a data line 202, and the second terminal of the thin film transistor 25 is connected to the pixel electrode 231. The thin film transistor 25 serves as a switching element of the pixel. Under the control of a scan signal transmitted by the scan line 201, the thin film transistor 25 of the pixel can be turned on or off, thereby realizing the transmission of a data voltage provided by the data line 202 to the pixel electrode 231 when the thin film transistor 25 is turned on. The projection of the thin film transistor 25 onto the underlay 21 does not overlap the projection of the second end of the photo spacer 11 onto the underlay 21, that is, when the photo spacer 11 is provided, the photo spacer 11 needs to avoid the region where the thin film transistor 25 is provided, thereby ensuring the flatness of the region where the photo spacer 11 is located, avoiding increasing the sliding probability of the photo spacer 11, and reducing the probability of dynamic pressure-induced bright spots occurring.

On the basis of the above embodiments, there are different arrangement modes for the photo spacers 11, and two feasible arrangement modes are disclosed below.

In some embodiments, with continued reference to FIG. 1 to FIG. 4, the projection of the photo spacer 11 onto the underlay 21 is a rectangle. The rectangle includes a first side 51 and a third side 53 extending along a third direction X3, a second side 52 and a fourth side 54 extending along a fourth direction X4. A length w1 of the first side 51 is greater than a length w2 of the second side 52, and an extension direction of the second electrode 2312 is parallel to an extension direction of the first side 51.

In some embodiments, the shape of the photo spacer 11 may be a cuboid or a frustum. The projection of the photo spacer 11 onto the underlay 21 is a rectangle. The rectangle includes the first side 51 and the third side 53 extending along the third direction X3, and the second side 52 and the fourth side 54 extending along the fourth direction X4. The length w1 of the first side 51 is greater than the length w2 of the second side 52, and the extension length of the photo spacer 11 along the third direction X3 is greater than the extension length of the photo spacer 11 along the fourth direction X4. In this case, to ensure the limiting of the second electrode 2312 in the pixel electrode 231 on the photo spacer 11, the extension direction of the second electrode 2312 may be set parallel to the extension direction of the first side 51, so that the provision of the second electrode 2312 can reduce the sliding range of the photo spacer 11, avoiding debris generation caused by the photo spacer 11 scratching the PI alignment film, and reducing the probability of dynamic pressure-induced bright spots occurring.

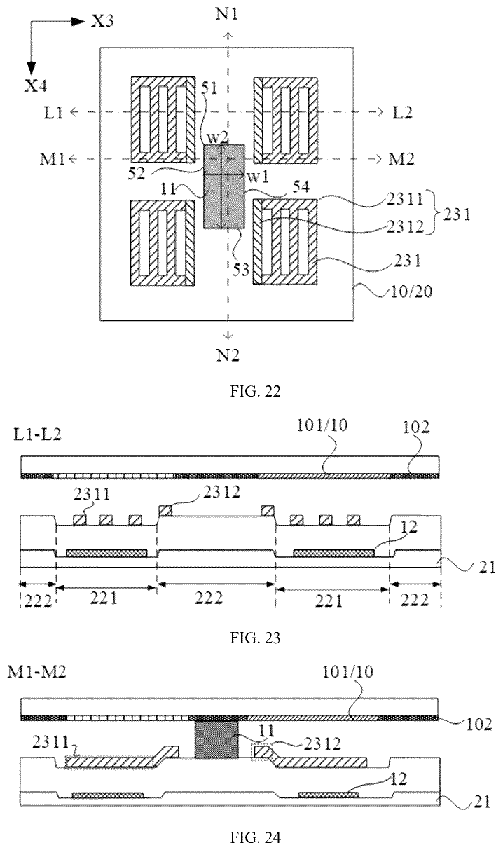

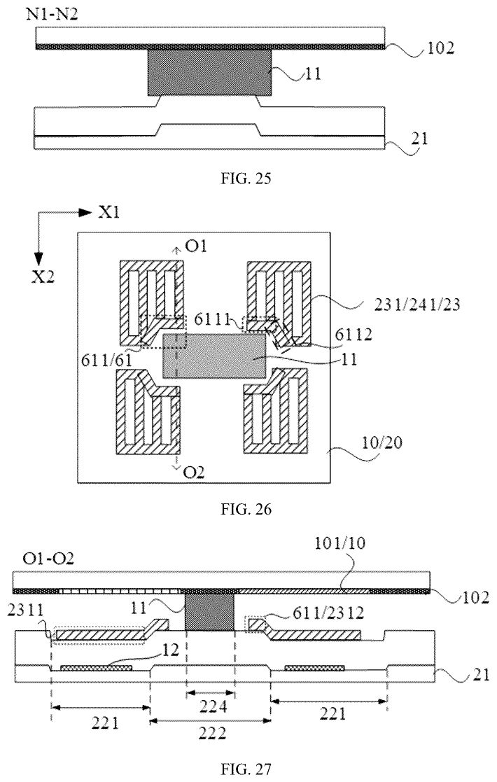

FIG. 22 is a schematic structural view of another display panel according to an embodiment of the present application. FIG. 23 is a schematic cross-sectional view of the exemplary embodiment shown in FIG. 22 taken along section line L1-L2, FIG. 24 is a schematic cross-sectional view of FIG. 22 taken along section line M1-M2. FIG. 25 is a schematic cross-sectional view of the exemplary embodiment shown in FIG. 22 taken along section line N1-N2. According to the exemplary embodiments shown in FIG. 22 to FIG. 25, the projection of the photo spacer 11 onto the underlay 21 is a rectangle. The rectangle includes a first side 51 and a third side 53 extending along a third direction X3 and a second side 52 and a fourth side 54 extending along a fourth direction X4. A length w2 of the second side 52 is greater than a length w1 of the first side 51, and an extension length of the photo spacer 11 along the fourth direction X4 is greater than an extension length of the photo spacer 11 along the third direction X3. In this case, to ensure the limiting of the second electrode 2312 in the pixel electrode 231 on the photo spacer 11, the extension direction of the second electrode 2312 may be set parallel to the extension direction of the second side 52, so that the provision of the second electrode 2312 can reduce the sliding range of the photo spacer 11, avoiding debris generation caused by the photo spacer 11 scratching the PI alignment film, and reducing the probability of dynamic pressure-induced bright spots occurring.

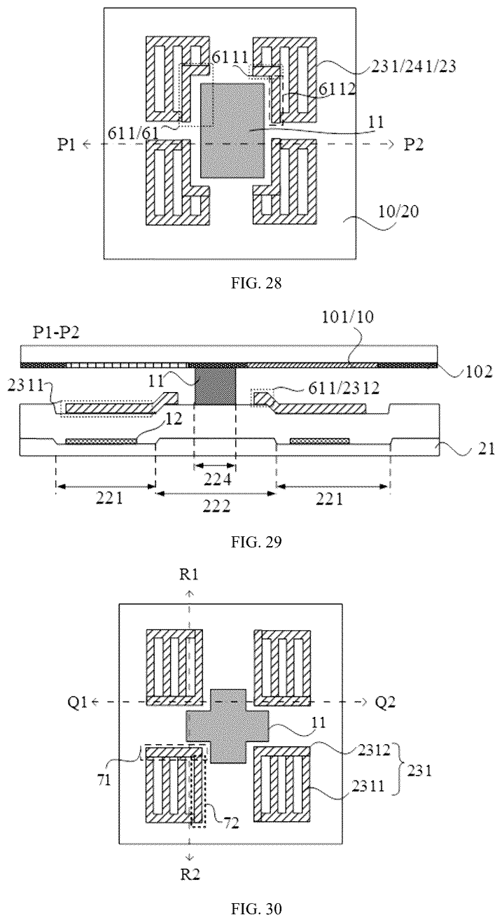

FIG. 26 is a schematic structural view of another display panel according to an embodiment of the present application. FIG. 27 is a schematic cross-sectional view of the exemplary embodiment shown in FIG. 26 taken along section line O1-O2. FIG. 28 is a schematic structural view of another display panel according to an embodiment of the present application. FIG. 29 is a schematic cross-sectional view of FIG. 28 taken along section line P1-P2. According to the exemplary embodiments shown in FIG. 26 to FIG. 29, the electrode layer 23 includes a plurality of pixel electrode groups 241. A respective pixel electrode group 241 includes four pixel electrodes 231 arranged in a 2×2 array, and the four pixel electrodes 231 are provided around the photo spacer 11. Four pixels corresponding to the pixel electrode group 241 are each provided with a photo spacer avoidance region 61, and the pixel electrodes 231 in the pixel electrode group 241 are each provided with a fourth electrode 611 located in the photo spacer avoidance region 61, so that the projection of the second end of the photo spacer 11 onto the underlay 21 does not overlap a projection of the pixel electrode 231 onto the underlay 21.

In some embodiments, the four pixel electrodes 231 in the pixel electrode group 241 are arranged in the array and provided around the photo spacer 11. The four pixels corresponding to the pixel electrode group 241 are each provided with the photo spacer avoidance region 61. The extension length of the pixel electrode 231 along the first direction X1 is different from the extension length of the pixel electrode 231 along the second direction X2. The extension length of the pixel electrode 231 adjacent to the photo spacer corresponding region 224 and located in the first region 221 is adjusted to be shortened. In some embodiments, such as the exemplary embodiments shown in FIG. 26 and FIG. 28, different adjustment methods for the extension length are adopted to realize its electrical connection to the fourth electrode 611 located in the second region, such that the fourth electrode 611 located in the second region is located in the photo spacer avoidance region 61. The projection of the second end of the photo spacer 11 onto the underlay 21 overlaps a projection of the photo spacer avoidance region 61 onto the underlay 21 but does not overlap the projection of the pixel electrode 231 onto the underlay 21. The design of the photo spacer avoidance region 61 of the pixel is conducive to increasing the support area of the photo spacer 11 and improving its support performance. The pixel electrode 231 includes the fourth electrode 611 located in the photo spacer avoidance region 61, and the fourth electrode 611 is reused as the second electrode 2312. The fourth electrode 611 can limit the photo spacer 11, reducing the sliding range of the photo spacer 11, avoiding debris generation caused by the photo spacer 11 scratching the PI alignment film, and reducing the probability of dynamic pressure-induced bright spots occurring.

Further, with continued reference to FIG. 26 and FIG. 27, the fourth electrode 611 is provided at an edge on a side of a corresponding pixel electrode 231 close to the photo spacer avoidance region 61. In some embodiments, each of the four pixel electrodes 231 may be correspondingly provided with the fourth electrode 611. The fourth electrode 611 is provided at the edge on the side of the pixel electrode 231 close to the photo spacer avoidance region 61. As such, the fourth electrodes 611 of the four pixel electrodes 231 limit the photo spacer 11 within a space formed by the four fourth electrodes 611, effectively reducing the sliding range of the photo spacer 11, avoiding debris generation caused by the photo spacer 11 scratching the PI alignment film, and reducing the probability of dynamic pressure-induced bright spots occurring.

Further, with continued reference to FIG. 26 and FIG. 27, a projection of the fourth electrode 611 onto the underlay 21 at least partially surrounds two side edges of the second end of the photo spacer 11. In some embodiments, each of the four pixel electrodes 231 is correspondingly provided with the fourth electrode 611 located in the photo spacer avoidance region 61, and the fourth electrode 611 is located at the edge on the side of the pixel electrode 231 close to the photo spacer avoidance region 61. The projection of the fourth electrode 611 onto the underlay 21 at least partially surrounds two side edges of the second end of the photo spacer 11, such that the fourth electrode 611 of each pixel electrode 231 limits one corner of the photo spacer 11, avoiding the sliding of the photo spacer 11, which would otherwise cause debris generation caused by the photo spacer 11 scratching the PI alignment film and further lead to dynamic pressure-induced bright spots.

On the basis of the above embodiments, there are different arrangement modes for the fourth electrode 611, and two feasible arrangement modes are shown below.

According to the exemplary embodiments shown in FIG. 28 and FIG. 29, the fourth electrode 611 includes a first sub-electrode 6111 and a second sub-electrode 6112 connected to each other. The first sub-electrode 6111 corresponds to one side edge of the second end of the photo spacer 11, and the second sub-electrode 6112 corresponds to the other side edge of the second end of the photo spacer 11. An included angle between the first sub-electrode 6111 and the second sub-electrode 6112 is 90°.

According to the exemplary embodiments shown in FIG. 27 and FIG. 28, the fourth electrode 611 includes a first sub-electrode 6111 and a second sub-electrode 6112 connected to each other. The first sub-electrode 6111 corresponds to one side edge of the second end of the photo spacer 11, and the second sub-electrode 6112 corresponds to the other side edge of the second end of the photo spacer 11. An included angle between the first sub-electrode 6111 and the second sub-electrode 6112 is greater than 90°. Both of the above embodiments may ensure that the fourth electrode 611 can limit the four corners of the photo spacer 11, avoiding the sliding of the photo spacer 11, reducing the probability of the photo spacer 11 scratching the PI alignment film, and ensuring the display effect of the display panel.

In some embodiments, with continued reference to FIG. 1 to FIG. 4, a width range of the second electrode 2312 is 2 μm to 4 μm. If the width of the second electrode 2312 is less than 2 μm, it is difficult to achieve the limiting effect of the second electrode 2312 on the photo spacer 11. If the width of the second electrode 2312 is greater than 4 μm, the second electrode 2312 will occupy a larger area. Therefore, reasonably setting the width of the second electrode 2312 within the range of 2 μm to 4 μm ensures the limiting effect of the second electrode 2312 on the photo spacer 11, avoiding debris generation caused by the photo spacer 11 scratching the PI alignment film, and ensuring the display effect of the display panel.

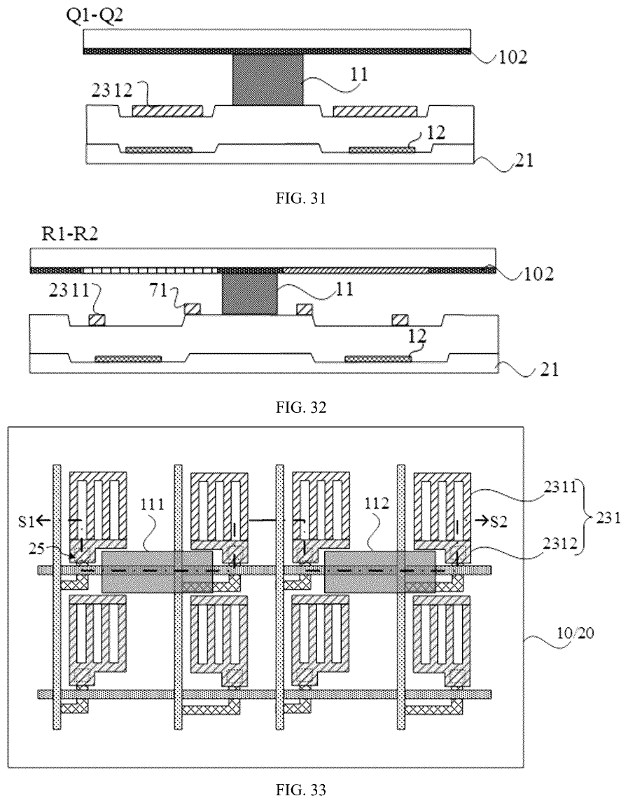

FIG. 30 is a schematic structural view of another display panel according to an embodiment of the present application. FIG. 31 is a schematic cross-sectional view of the exemplary embodiment shown in FIG. 30 taken along section line Q1-Q2. FIG. 32 is a schematic cross-sectional view of the exemplary embodiment shown in FIG. 30 taken along section line R1-R2. As shown in FIG. 30 to FIG. 32, a projection shape of the photo spacer 11 onto a plane of the second substrate is a cross shape, the second electrode 2312 includes a third sub-electrode and a fourth sub-electrode, and an extension direction of the third sub-electrode and an extension direction of the fourth sub-electrode are parallel to a horizontal side and a vertical side of the cross shape, respectively.

In some embodiments, the photo spacer 11 may be configured as a cross-shaped column, the projection shape of the photo spacer 11 onto the plane of the second substrate 20 is a cross shape, which effectively increases the contact area between the photo spacer 11 and the first substrate 10, and in turn enhances the supporting force of the photo spacer 11. The second electrode 2312 of the pixel electrode 231 includes the third sub-electrode 71 and the fourth sub-electrode 72. Exemplarily, the photo spacer 11 is surrounded by four pixel electrodes 231, and the extension directions of the third sub-electrode 71 and the fourth sub-electrode 72 of each pixel electrode 231 are parallel to the horizontal side and the vertical side of the cross shape, respectively, so that the third sub-electrodes 71 and the fourth sub-electrodes 72 of the four pixel electrodes 231 can limit the movement range of the photo spacer 11, avoiding debris generation caused by the photo spacer 11 scratching the PI alignment film, reducing the probability of dynamic pressure-induced bright spots occurring, and ensuring the display effect of the display panel.

It should be noted that FIG. 18 to FIG. 32 merely show partial structures and omit some film layers. FIG. 22, FIG. 26, FIG. 28, and FIG. 30 merely show the pixel electrode 231 and the photo spacer 11, and the structures of the data line, the scan line. The thin film transistor may be similar to those in the foregoing embodiments, and will not be described in detail herein.

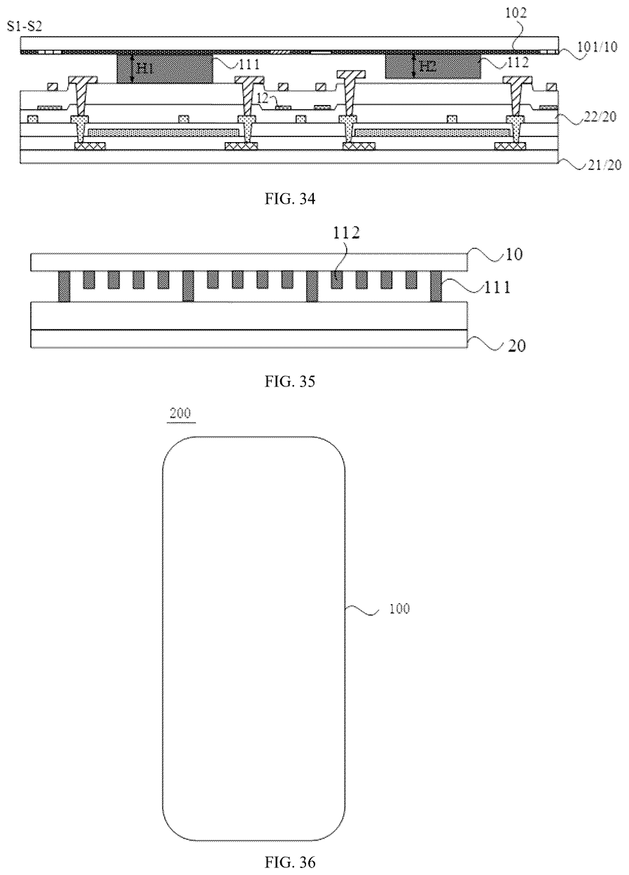

FIG. 33 is a schematic structural view of another display panel according to an embodiment of the present application. FIG. 34 is a schematic cross-sectional view of the exemplary embodiment shown in FIG. 33 taken along section line S1-S2. As shown in FIG. 33 and FIG. 34, the photo spacers 11 include first photo spacers 111 and second photo spacers 112, the second ends of the first photo spacers 111 contact the second substrate 20, and the second photo spacers 112 are spaced apart from the second substrate 20 by a preset interval.

In some embodiments, the photo spacers 11 in the display panel include the first photo spacers 111 and the second photo spacers 112, where the first photo spacers 111 are main supporting components. The first ends of the first photo spacers 111 contact the first substrate 10 and the second ends of the first photo spacers 111 contact the second substrate 20. The first photo spacers 111 can maintain the thickness of the liquid crystal cell, bear the pressure inside the display panel, ensure the thickness uniformity of the liquid crystal cell, avoid display non-uniformity, and ensure the overall display effect of the display panel. The first ends of the second photo spacers 112 contact the first substrate 10, and the second ends of the second photo spacers 112 are spaced apart from the second substrate 20 by the preset interval; that is, the height of the second photo spacers 112 is smaller than the thickness of the liquid crystal cell. When the display panel is subjected to an external force and is deformed, the second photo spacers 112 are used to play a certain buffering role, share a part of the external force, prevent the first photo spacers 111 from being deformed or broken, and enable the display panel to restore the original shape after the external force disappears.

In some embodiments, with continued reference to FIG. 33 and FIG. 34, a height range of the first photo spacers 111 is 1.8 μm to 3.0 μm, and a height range of the second photo spacers 112 is 1.3 μm to 2.6 μm. Herein, the heights of the first photo spacers 111 and the second photo spacers 112 are reasonably set. Generally, the height H1 of the first photo spacers 111 is greater than the height H2 of the second photo spacers 112, and the height of the first photo spacers 111 is consistent with the thickness of the liquid crystal cell, so as to maintain the thickness of the liquid crystal cell by the first photo spacers 111, ensuring the display effect of the display panel. There is a reasonable height difference between the second photo spacers 112 and the first photo spacers 111, so as to avoid the height of the second photo spacers 112 being excessively large, which would otherwise cause the second photo spacers 112 to contact the second substrate 20 too early when the display panel is subjected to an external impact, resulting in non-uniform thickness of the liquid crystal cell and thus non-uniform display. Furthermore, this avoids the height of the second photo spacers 112 being excessively small, which would otherwise cause the second photo spacers 112 to fail to contact the second substrate 20 in a timely manner when the display panel is subjected to an external impact, which makes it difficult to play a buffering effect and thus leading to the deformation of the display panel and non-uniform display.

FIG. 35 is a schematic structural view of another display panel according to an embodiment of the present application. According to the exemplary embodiment shown in FIG. 35, a number of the first photo spacers 111 is less than a number of the second photo spacers 112. Since the two ends of each first photo spacer 111 contact the first substrate 10 and the second substrate 20, the thickness of the liquid crystal cell is ensured. Further, setting the number of the first photo spacers 111 to be less than the number of the second photo spacers 112 avoids the number of the first photo spacers 111 being too large, which would otherwise restrict the flow of liquid crystal and affect the display effect. Moreover, reasonably setting the number of the second photo spacers 112 ensures the stress-sharing effect of the second photo spacers 112 and the compression resistance effect of the display panel. It should be noted that FIG. 35 merely exemplarily shows the first photo spacers 111 and the second photo spacers 112, and omits some film layers.

In some embodiments, with continued reference to FIG. 35, a distribution density of the first photo spacers 111 is less than a distribution density of the second photo spacers 112. A plurality of second photo spacers 112 may be provided between two adjacent first photo spacers 111. The first photo spacers 111 may be utilized to ensure the liquid crystal thickness precision to avoid excessively high distribution density of the first photo spacers 111, which would otherwise affect the fluidity of the liquid crystal and result in display non-uniformity. Setting the distribution density of the first photo spacers 111 to be less than the distribution density of the second photo spacers 112 enables the second photo spacers 112 to disperse the concentrated stress when the display panel is subjected to an impact of an external force, avoiding the first photo spacers 111 from undergoing deformation or fracture, and to ensure that the display panel restores to its original shape after the external force disappears.

FIG. 36 is a schematic structural view of a display apparatus according to an embodiment of the present application. According to the exemplary embodiment shown in FIG. 36, the display apparatus 200 includes the display panel 100 described in the foregoing embodiments. It should be noted that, since the display apparatus provided in this embodiment has the same or corresponding beneficial effects as the display panel in the foregoing embodiments, it will not be described in detail herein.

It should be noted that the display apparatus according to the embodiment has the same or corresponding beneficial effects as the display panel of the above embodiments, which will not be repeated herein. The display apparatus 200 according to embodiment of the present application may be a mobile phone as shown in FIG. 36, or any electronic product with a display function, including but not limited to the following categories: televisions, laptop computers, desktop displays, tablet computers, digital cameras, smart bracelets, smart glasses, vehicle-mounted displays, medical devices, industrial control equipment, touch interactive terminals, etc., which are not specifically limited in the embodiments of the present application.

The above specific implementations do not limit the protection scope of the present application. Those of ordinary skill in the art should understand that various modifications, combinations, sub-combinations, and substitutions can be made according to design requirements and other factors. Any modifications, equivalent substitutions and improvements made within the spirit and principle of the present application shall fall within the protection scope of the present application.

What is claimed is:

1. A display panel, comprising a first substrate and a second substrate provided opposite to each other, and a plurality of photo spacers located between the first substrate and the second substrate;
wherein a first end of a respective photo spacer is fixed on a side of the first substrate close to the second substrate, and a second end of the photo spacer either contacts the second substrate or is spaced apart from the second substrate by a preset interval; and
wherein the second substrate comprises an underlay, and an insulating layer and an electrode layer stacked on one side of the underlay, the insulating layer comprises a first region and a second region, and a thickness of the first region is smaller than a thickness of the second region; the electrode layer comprises a plurality of pixel electrodes, and a projection of at least a partial region of a respective pixel electrode onto the underlay is located within a projection of the first region onto the underlay, a partial region of the second region is a photo spacer corresponding region, and a projection of the second end of the photo spacer onto the underlay is located within the photo spacer corresponding region.

2. The display panel according to claim 1, wherein at least a part of the pixel electrodes comprise a first electrode and a second electrode, the first electrode is electrically connected to the second electrode, and the second electrode is located on a side of the first electrode close to the photo spacer, a projection of the first electrode onto the underlay is located within the projection of the first region onto the underlay, and a projection of the second electrode onto the underlay is located within a projection of the second region onto the underlay.

3. The display panel according to claim 2, wherein an extension direction of the first electrode and an extension direction of the second electrode are different.

4. The display panel according to claim 1, wherein the electrode layer further comprises a third electrode located on a side of the pixel electrode close to the photo spacer, a projection of the pixel electrode onto the underlay is located within the projection of the first region onto the underlay, a projection of the third electrode onto the underlay is located within the projection of the second region onto the underlay, and the third electrode is connected to a preset potential.

5. The display panel according to claim 1, wherein projections of the pixel electrodes onto the underlay are all located within the projection of the first region onto the underlay.

6. The display panel according to claim 1,
wherein the electrode layer comprises a plurality of pixel electrode groups, and a respective pixel electrode group comprises four pixel electrodes arranged in a 2×2 array; and
wherein the four pixel electrodes are provided around the photo spacer.

7. The display panel according to claim 6, wherein projections of the four pixel electrodes onto the underlay do not overlap the projection of the second end of the photo spacer onto the underlay.

8. The display panel according to claim 6,
wherein the second substrate further comprises a plurality of scan lines extending along a first direction and arranged along a second direction, and a plurality of data lines extending along the second direction and arranged along the first direction; and
wherein four thin film transistors are provided corresponding to the pixel electrode groups in one-to-one correspondence with the pixel electrodes, a control terminal of a respective thin film transistor is connected to a corresponding scan line, a first terminal of the thin film transistor is connected to a corresponding data line, and a second terminal of the thin film transistor is connected to a corresponding pixel electrode, a projection of the thin film transistor onto the underlay does not overlap the projection of the second end of the photo spacer onto the underlay.

9. The display panel according to claim 1, wherein in the first region, a first thickness range of the insulating layer is 2.0 μm to 3.0 μm; and in the second region, a second thickness range of the insulating layer is 2.5 μm to 3.2 μm.

10. The display panel according to claim 2, wherein the insulating layer further comprises a step region located between the first region and the second region, the pixel electrode comprises a connecting portion that electrically connects the first electrode and the second electrode, and along a direction from the insulating layer to the underlay, the connecting portion covers at least a part of the step region.

11. The display panel according to claim 2, wherein the projection of the photo spacer onto the underlay is a rectangle, and the rectangle comprises a first side and a third side extending along a third direction, and a second side and a fourth side extending along a fourth direction; and
a length of the first side is greater than a length of the second side, and an extension direction of the second electrode is parallel to an extension direction of the first side; or a length of the second side is greater than a length of the first side, and an extension direction of the second electrode is parallel to an extension direction of the second side.

12. The display panel according to claim 2, wherein the electrode layer comprises a plurality of pixel electrode groups, a respective pixel electrode group comprises four pixel electrodes arranged in a 2×2 array, and the four pixel electrodes are provided around the photo spacer; and
four pixels corresponding to the pixel electrode group are each provided with a photo spacer avoidance region, and the pixel electrodes in the pixel electrode group are each provided with a fourth electrode located in the photo spacer avoidance region, so that the projection of the second end of the photo spacer onto the underlay does not overlap a projection of the pixel electrode onto the underlay.

13. The display panel according to claim 12, wherein the fourth electrode is provided at an edge on a side of a corresponding pixel electrode close to the photo spacer avoidance region.

14. The display panel according to claim 13, wherein the fourth electrode comprises a first sub-electrode and a second sub-electrode connected to each other, and a projection of the fourth electrode onto the underlay at least partially surrounds two side edges of the second end of each photo spacer.

15. The display panel according to claim 2, wherein a width range of the second electrode is 2 μm to 4 μm.

16. The display panel according to claim 2, wherein a projection shape of the photo spacer onto a plane of the second substrate is a cross shape, the second electrode comprises a third sub-electrode and a fourth sub-electrode, and an extension direction of the third sub-electrode and an extension direction of the fourth sub-electrode are parallel to a horizontal side and a vertical side of the cross shape, respectively.

17. The display panel according to claim 1, wherein the photo spacers comprise first photo spacers and second photo spacers, the second ends of the first photo spacers contact the second substrate, and the second ends of the second photo spacers are spaced apart from the second substrate by a preset interval.

18. The display panel according to claim 17, wherein a number of the first photo spacers is less than a number of the second photo spacers.

19. The display panel according to claim 17, wherein a distribution density of the first photo spacers is less than a distribution density of the second photo spacers.

20. A display apparatus, comprising a display panel, wherein the display panel comprises a first substrate and a second substrate provided opposite to each other, and a plurality of photo spacers located between the first substrate and the second substrate;
wherein a first end of a respective photo spacer is fixed on a side of the first substrate close to the second substrate, and a second end of the photo spacer either contacts the second substrate or is spaced apart from the second substrate by a preset interval; and
wherein the second substrate comprises a underlay, and an insulating layer and an electrode layer stacked on one side of the underlay, the insulating layer comprises a first region and a second region, and a thickness of the first region is smaller than a thickness of the second region; the electrode layer comprises a plurality of pixel electrodes, and a projection of at least a partial region of a respective pixel electrode onto the underlay is located within a projection of the first region onto the underlay, a partial region of the second region is a photo spacer corresponding region, and a projection of the second end of the photo spacer onto the underlay is located within the photo spacer corresponding region.
